(19) United States
(12) Patent Application Publication
(10) Pub. No.: US 2014/0298099 A1
(43) Pub. Date: Oct. 2, 2014

(54) INTELLIGENT DETECTION SYSTEM AND METHOD FOR DETECTING DEVICE FAULT

(71) Applicants: Min Tan, Beijing (CN); Xiaoguang Zhao, Beijing (CN); Zize Liang, Beijing (CN); En Li, Beijing (CN)

(72) Inventors: Min Tan, Beijing (CN); Xiaoguang Zhao, Beijing (CN); Zize Liang, Beijing (CN); En Li, Beijing (CN)

(73) Assignee: INSTITUTE OF AUTOMATION, CHINESE ACADEMY OF SCIENCES, Beijing (CN)

(21) Appl. No.: 13/976,882

(22) PCT Filed: Dec. 31, 2010
(86) PCT No.: PCT/CN10/80579

§ 371 Date: Jul. 10, 2013

(51) Int. Cl. G06F 11/07

(52) U.S. Cl. CPC G06F 11/079
USPC 714/37

(57) ABSTRACT

An intelligent detection system and detection method are presented. The system includes a central processing board (CPB), a data acquisition board (DAB), a synchronous communication board (SCB) and a plurality of connection plugs. For data transformation, the CPB, DAB and SCB are connected via the plurality of connection plugs. A plurality of sensors are connected to the intelligent detection system to collect the data reflecting the operation status of the device to be detected. The intelligent detection system and method achieve a real-time and accurate detection and diagnosis of the mechanical failure by detecting the temperature, the vibration and/or the noise signals of device.

### TECHNICAL FIELD

The invention relates to an intelligent detection system for detecting faulty operation of device, which combines an intelligent sensing technology and an embedded computer technology. Specifically, the present invention relates to an intelligent detection system and a method for device fault detection.

### BACKGROUND

For large-scale devices such as a CNC machine or a dedicated device, device operating conditions need to be tested during the operation for timely maintenance and guarantying safe running of the device. In current monitoring technology for monitoring the running condition of the device, a monitoring technology for monitoring the malfunction and running condition of electrical parts has been more popular. In addition, self-inspection of the electronic part is used to eliminate some hardware and software failures. However, monitoring of the running condition and parameters of mechanical parts in the device has several problems in the field of fault detection and diagnosis. The running monitoring of a NC machine tool spindle, a drive motor, a lathe bed and a tool database, is not only a necessary means to find hidden faults in advance and ensure safe operation of machine tools but also a basic dependency for machine maintaining. In general, a running status of the mechanical device can be accurately reflected by a temperature of rotating parts, the vibration of a clamping unit, and changes at serial ports during the operation.

However, in an existing technology, there is a lack of effective technical means to accurately monitor these parameters in a real-time. In most cases, it is dependent on eyes and ears of the maintenance person to distinguish noise and vibration in the operation. Whether points of failure can be determined accurately and effectively, is all a matter of experience of the maintenance person. Therefore, it is desirable to provide a device and method to ensure the efficiency and precision of fault detection.

### SUMMARY

In order to solve the existing detection problem of the operating condition and parameters of the mechanical parts of the device, an embodiment of the invention is directed to an intelligent detection system and method for detecting a device fault. For large-scale device, real-time and intelligent mechanical fault detection and diagnosis are done in an embodiment of the invention based on embedded technology.

According to an embodiment of the invention, an intelligent detection system for device fault detection is provided. The system is connected to a plurality of external sensors configured to collect processing data of a device to be detected. The system may comprise: a central processing board (CPB) 2 including a central processing unit (CPU) and a plurality of data interfaces connected to the CPU; a data acquisition board (DAB) 3 connected to one or more sensors and configured to process the data collected by the sensors; a synchronous communication board (SCB) 4 configured to maintain communication between the CPB and the DAB; and a plurality of connection plugs 1 configured to keep connection among the CPB, the DAB, and the SCB to realize data transformation; wherein, the CPU is configured to analyze the data collected by the sensors and issue an alarm information when the collected data does not fall into a preset range and it is determined that the device is in an abnormal status; and when the value of the collected data falls into the pre-set range, it is determined that the device is in a normal status.

In an embodiment, the plurality of sensors may include at least one of a vibration sensor, an acoustic sensor, and a temperature sensor.

In an embodiment, the CPU is configured to analyze the data collected by the temperature sensor, and the alarm information is issued when the value of the collected data does not fall into the preset range.

In an embodiment, the CPU is configured to analyze the signals collected by the vibration sensor to collect vibration amplitude, pre-set a normal range of the vibration amplitude and issue the alarm information when the collected vibration amplitude does not fall into the preset normal range of the vibration amplitude; and/or analyze the signals collected by the vibration sensor to collect a vibration frequency, pre-set a vibration frequency range for the normal status, and issue the alarm information when the vibration frequency collected does not fall into the pre-set vibration frequency range.

In an embodiment, the CPU is configured to analyze an acoustic signal collected by the acoustic sensor to collect an acoustic pressure level (SPL), issue the alarm information when the collected SPL is greater than a pre-set maximum; and/or and analyze an acoustic signal collected by the acoustic sensor to collect a acoustic frequency, pre-set an acoustic frequency range for the normal status and issue the alarm information when the collected acoustic frequency does not fall into the pre-set acoustic frequency range.

In an embodiment, the plurality of connection plugs comprise a PC104 bus.

In an embodiment, the plurality of data interfaces include at least one of a serial port, a 485-bus interface, a CAN bus interface, a network interface, and a photoelectric conversion interface.

In an embodiment, the temperature sensor is connected to the 485-bus interface, and the vibration sensor and the acoustic sensor are connected to DAB 3.

In an embodiment, DAB 3 is a multi-channel high speed data acquisition board.

In an embodiment, the system further comprises a self-operation status monitoring module configured to monitor the operation of the system and issue the alarm information in response to a faulty operation of the system.

In an embodiment, the faulty operation of the system status comprise at least one of no data collection by sensors, abnormal operation status of DAB, and an interruption of the connection among the data interfaces.

In accordance with another embodiment of the present invention, a method for device fault detection is provided. The system is connected to a plurality of sensors configured to collect processing data of a device to be detected. The system may comprise: a central processing board (CPB) 2, data acquisition board (DAB) 3, synchronous communication board (SCB) 4 and a plurality of connection plugs 1, the CPB 2, DAB 3 and SCB 4 are connected from each other via the plurality of connection plugs 1 for data transmission. The intelligent detection methods may comprise: initializing the system by initializing all devices and interfaces of the system; setting a operation mode of the system as a main controller or a slave controller; setting operation timings and task priorities of each device and interface respectively; collecting data according to the set timings and priorities; and analyzing the collected data to determine whether or not the device to be detected is in a normal status according to an analysis result.

In an embodiment the step of setting the operation timings may include setting the timings and the task priorities of data collection, data processing and data transmission for the plurality of sensors respectively.

In an embodiment, data transmission of a network interface is assigned a highest priority. Data collection of the temperature sensor is assigned a second priority. Data collections of vibration sensor and acoustic sensor are assigned a lowest priority.

In an embodiment, the step of analyzing further comprises: issuing the alarm when a value of the collected data does not fall into a pre-set range and determining that the device to be detected is in an abnormal status; determining that the device to be detected is in a normal status when the value of the collected data falls into the pre-set range and returning to the step of setting the operation mode for a next detection.

In an embodiment, the step of analyzing further comprises setting a normal temperature range in advance, and issuing the alarm information when the value of the data collected by the temperature sensor does not fall into the normal temperature range.

In an embodiment, the step of analyzing further comprises: analyzing a vibration signal collected by a vibration sensor to collect vibration amplitude, presetting a normal range of the vibration amplitude, and issuing the alarm information when the collected vibration amplitude does not fall into the normal range of the vibration amplitude; and/or analyzing the vibration signal collected by the vibration sensor to collect a vibrational frequency, pre-setting a normal range of the vibrational frequency, comparing the vibrational frequency collected with the pre-set normal range of the vibrational frequency, and issuing the alarm information the vibration frequency collected does not fall into the pre-set vibration frequency range.

In an embodiment, the step of analyzing further comprises: analyzing an acoustic signal collected by an acoustic sensor to collect a sound pressure level (SPL), pre-setting a SPL maximum and issuing the alarm when the SPL collected is greater than the maximum; and/or analyzing an acoustic signal collected by an acoustic sensor to collect an acoustic frequency, pre-setting a normal range of the acoustic frequency, comparing the acoustic frequency collected with the pre-set normal range of the acoustic frequency, and issuing the alarm information when the collected acoustic frequency does not fall into the pre-set acoustic frequency range.

In an embodiment, the method further comprises a step of self-operation status monitoring the operation of the system and issuing the alarm information in response to a faulty operation of the system. In addition, the faulty operation comprises at least one of no data collection by sensors, abnormal operation status of DAB, and an interruption of the connection among the data interfaces status.

As mentioned above, according to an embodiment of the present invention, the temperature sensor, vibration sensor and acoustic sensor are provided in the parts of the device to be detected so that the temperature of the rotating parts, the vibration of the clamping unit and the changes of the acoustic signal may be detected in real time during processing. Thus, the problems and the point of failure can be found timely to avoid further device damage. Therefore, the accuracy and efficiency of the device fault detection are improved and the effective guarantee for the safe running of the device is implemented.

### BRIEF DESCRIPTION OF THE DRAWINGS

FIG. 1 is a diagram that schematically shows the intelligent detection system according to an embodiment the present invention;

FIG. 2 is a diagram that shows the central processing board shown in FIG. 1;

FIG. 3 shows a perspective drawing of the intelligent detection system according to an embodiment of the present invention;

FIG. 4 shows a flowchart of the intelligent detection method for the intelligent detection system according to an embodiment of the present invention;

FIG. 5 shows a topology structure of a BP neural network implemented by an embodiment of the present invention;

FIG. 6 shows vibration frequency characteristics of the device to be detected under the normal status;

FIG. 7 shows the vibration frequency characteristics of the device to be detected in the failure status.

### DETAILED DESCRIPTION

To make technical schemes and advantages of the present invention clear, a more detailed description for this invention is given by embodiments with reference to the drawings. It should be noted that, the described embodiments are provided by way of examples, but are not limiting.

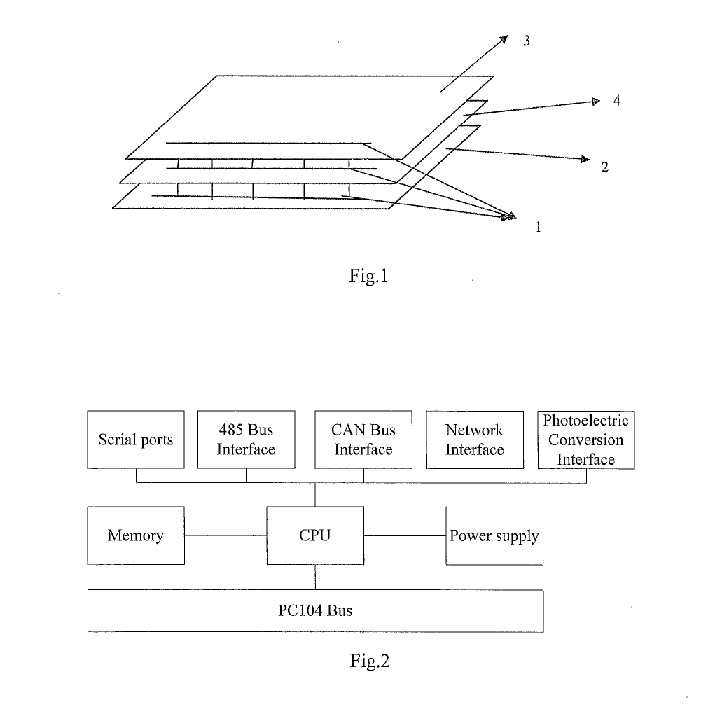

FIG. 1 is a diagram that schematically shows the intelligent detection system according to an embodiment of the present invention.

As shown in FIG. 1, the intelligent detection system may comprise: a central processing board (CPB) 2, a data acquisition board (DAB) 3, and a synchronous communication board (SCB) 4.

A data bus of the CPB comprises a compatible PC104 bus which may be implemented by row cylindrical connectors. One end of the connectors is a jack and the other is a contact pin. The CPB, DAB, and SCB according to an embodiment of the invention are all connected to the connectors so as to allow the circuit boards to transmit data. In an embodiment of the invention, an embedded CPB is used as the CPB on which a CPU is carried to control the operation of the intelligent detection system.

The SCB 4 is connected between the CPB 2 and the DAB 3 and a timing adjustment circuit is provided on the SCB 4. The SCB 4 may adjust the timing of the communication between the CPB 2 and the DAB 3 to maintain synchronization communication between the CPB and the DAB. Connection plugs 1 are provided on the SCB 2 to keep the electrical connection among the CPB 2, the DAB 3 and the SCB 4.

The DAB 3 may comprise a plurality of data collection channels and registers. The registers are used to store the current data in the channels. The data in registers can be read out by the CPU through the PC104 bus. According to an embodiment of the invention, a multi-channel high speed data acquisition board such as DM6430HR-1 is used as the DAB.

FIG. 2 is a diagram that shows the central processing board shown in FIG. 1. As shown in FIG. 2, according to an embodiment of the invention, the CPB may comprise an ARM9 microprocessor chip as the CPU, for example. A memory can be extended to store operation files and temporal data. In an embodiment, a flash memory with an optional storage capacity of 32M is used to guarantee high data access rate.

The intelligent detection system may use a PC104 bus. The CPU can be connected with a peripheral device such as the DAB and the SCB and control their processing via the PC104 bus.

As shown in FIG. 2, a plurality of data interfaces are integrated on CPB and connected between the peripheral devices and the CPU for transmitting data and commands. The data interfaces correspond to different data interface standards respectively such as a serial interface, a 485 bus interface, a CAN interface (CAN bus is a standard bus), a network interface and a photoelectric conversion interface. In an embodiment, a standard 232 serial interface may be used.

According to an embodiment of the present invention, a plurality of sensors such as a vibration sensor, an acoustic sensor, a temperature sensor, a pressure sensor and an acceleration sensor, are used to collect the data that reflects the real-time operating status of the device to be detected. Different sensor outputs different data type. Therefore, the different data interfaces are used to transmit data to the CPU on CPB respectively. According to different type of the output data, the different sensors are connected to the interfaces with the different standard, such as the 232 interface, the 485 interface, the CAN interface, the network interface and the photoelectric conversion interface. According to the embodiment of the invention, a temperature sensor is connected to the 485 interface while the vibration sensor and the acoustic sensor are directly connected to the DAB to collect the status parameter information which reflects the operating status of the device to be detected during the real-time processing, such as vibration and noise. In an embodiment, the 485 interface is connected to 16 temperature sensors while the high speed data acquisition board is connected to 7 vibration sensors and 4 acoustic sensors.

In addition, the intelligent detection system of an embodiment of the present invention is provided with a power supply and a corresponding supply circuit to provide constant power such as 3V, 5V, or 12V, to the CPU, the DAB and the external sensors.

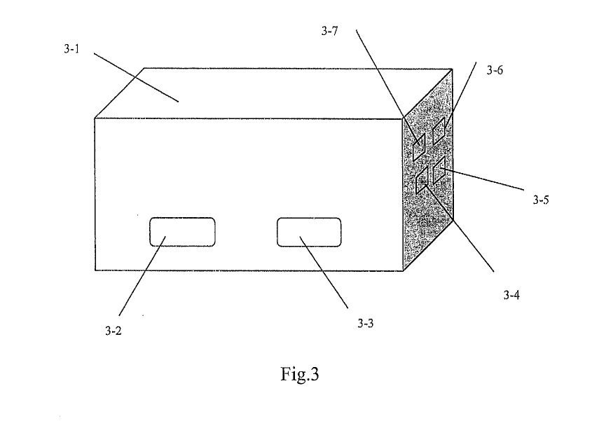

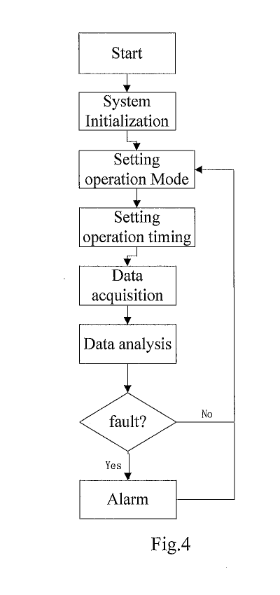

FIG. 3 shows a perspective drawing of the intelligent detection system according to an embodiment of the present invention.

As shown in FIG. 3, the intelligent detection system of an embodiment of the present invention is packaged in a house 3-1, which accommodates and protects the components of the system therein.

As shown in FIG. 3, two sides of the house 3-1 are respectively provided with two openings. In addition, sockets for the power supply, sensor leads and external communication interfaces are mounted on the house.

A front of the house 3-1 is provided with the two openings and two D sockets (a universal socket with the similar shape to D). One of the D sockets is a power outlet 3-2 for connecting a 220V power supply and the other is a sensor wire plug 3-3.

There are four openings on one side of the house 3-1 for the connections to the RS232 interface 3-4, the 485 interface 3-5, the CAN interface 3-6 and the network interface 3-7 respectively. These interfaces are connected to the external lines for data transmission.

FIG. 4 shows a flowchart of the intelligent detection method for the intelligent detection system according to an embodiment of the present invention.

As shown in FIG. 4, the intelligent detection methods of the present invention may comprise following steps of:

System initialization: initializing the system by initializing all devices and the interfaces of the system. Specifically, the CPB 2, the DAB 3, and the SCB 4 are detected to determine whether the devices connected through the external interfaces are in the normal status;

Operation mode configuration: according to the setting of the device to be detected, the operation mode of the system is set as a main controller or a slave controller. For example, if the intelligent system is set to operate independently by the device to be detected, its operation mode is set as the main controller. In this case, the control commands generated by the intelligent system are used to control the operation of other external devices. On the other hand, if the device to be detected is set to control the operation of the intelligent system, the operation mode of the detection system is set as a slave controller. In this case, the intelligent system is used as the external device of the main controller to respond to the control commands. The example flow is given in the case that the intelligent system is used as the main controller. In addition, the step of the operation mode configuration may be carried out automatically according to the pre-set parameters or carried out during operation of the intelligent detection system manually.

Operation timing configuration: according to the type of the device to be detected, the operation timings and task priorities of each device and interface are set respectively to keep the normal operation status for the intelligent detection system. For example, if the device to be detected is sensitive to the temperature parameter, the temperature sensor may be assigned a high priority; if it is sensitive to the vibration or noise parameters, the vibration sensor or the acoustic sensor may be assigned a higher priority. The step of the operation timings configuration may include setting the timings and the task priorities of data collection, data processing and data transmission for the plurality of sensors respectively.

In an embodiment, the task priorities may be set as follows: the data transmission task of a network interface is assigned a highest priority; data collection task of the temperature sensor connected to the 486 bus is assigned a second priority; and data collection task of the vibration sensor and the acoustic sensor connected by DAB are assigned a lowest priority.

Data acquisition: the intelligent detection system performs data collection in accordance with the pre-set timings and task priorities so that the operating data is collected by the sensors provided at detection positions for the device to be detected.

Data analyzing: the intelligent detection system analyzes the collected data and determines whether the device is in a normal status or not according to analysis result. In particular, the alarm is issued when a value of the collected data does not fall into a pre-set range so that the device to be detected is determined in an abnormal status. The device to be detected is determined in a normal status when the value of the collected data falls into the pre-set range and then return to the step of setting the operation mode for a next detection.

According to an embodiment of the present invention, for each sensor (the temperature sensors, the vibration sensors and the acoustic sensors, for example), the method for analyzing the collected data is described as follows.

Temperature data: a normal temperature range is set in advance, and the alarm information is issued when the value of the data collected by the temperature sensor does not fall into the normal temperature range.

Vibration data: the vibration sensor collects the vibration signal of the objective device. The alarm is issued when the collected vibration signal is abnormal. The step of analyzing the vibration signal comprises the analysis of the vibration amplitude and/or the vibration frequency.

For the vibration amplitude, a normal range of the vibration amplitude is pre-set. During the step of analyzing, the vibration amplitude is obtained by processing the vibration signal in a time domain. The alarm is issued when the vibration amplitude obtained does not fall into the normal range of the vibration amplitude.

For the vibration frequency, the frequency characteristic of the vibration signal in the normal status is pre-set. During the step of analyzing, the vibration signal is transformed into periodic values in frequency domain using Fourier transform or wavelet analysis for example. The frequency value is compared with the pre-set frequency characteristic of the vibration signal in the normal status and the alarm is issued when the collected vibration frequency does not fall into the pre-set vibration frequency range.

Acoustic data: the process for the acoustic data is similar to that for the vibration signal. The SPL maximum and frequency characteristic of the acoustic signal in the normal status are set in advance. The alarm is issued when the collected SPL is greater than the maximum. In addition, the frequency characteristic of the acoustic signal may be obtained using the Fourier transform or the wavelet analysis. The obtained acoustic frequency is compared with the pre-set normal range of the acoustic frequency and the alarm is issued when the obtained acoustic frequency does not fall into the pre-set acoustic frequency range.

Hereinafter, the mechanical failure of a CNC machine tool spindle is taken as an example to describe the intelligent detection system of an embodiment of the present invention.

To detect the fault condition of the CNC machine tool spindle, the sensors can be arranged as follows.

Temperature sensor: two temperature sensors are provided on a shaft sleeve of the spindle. The range of the collected values by a temperature sensor may be set as 10-80 degrees Celsius.

In the process of detection, if the temperature value collected by the sensor is between 10-80 degrees Celsius, it is determined that the device status is normal. Otherwise, the alarm is issued.

Vibration sensor: two vibration sensors are respectively provided on an axial shaft and a radial shaft of spindle to detect the axial vibration and radial vibration. The range of the vibration amplitude of the axial shaft and the radial shaft is set as −0.5 mm-+0.5 mm respectively.

In the process of detection, if the amplitude collected by vibration sensors is between −0.5 mm and +0.5 mm, it is determined that the device status is normal. Otherwise, the alarm is issued.

Acoustic sensor: four acoustic sensors are respectively provided around the spindle. A probe faces a direction of the spindle to collect the voice from the spindle. The range of the SPL may be set as 50 DB-94 DB.

In the process of detection, if the SPL collected by acoustic sensors is between 50 DB and 94 DB, it is determined that the device status is normal. Otherwise, the alarm is issued.

The collection and processing of the frequency characteristic of the vibration signal is described in detail, for example.

First, the frequency characteristic feature extraction from the vibration signal in the normal status is described.

The vibration sensors collect the vibration signal of the spindle in the form of vibration waveform during the normal operation. A sampling frequency is 10 kHz while the sample output is ±5V. Next, four-order Daubenchies wavelet with three layers wavelet packet decomposition is executed on each vibration waveform collected by sampling so that eight bands are obtained. Then, total energy for the eight bands is calculated respectively to construct eigenvectors. The eigenvectors are normalized and the normalized eigenvectors for a single sampling of the vibration signal are shown in TABLE. 1.

TABLE 1

| | | | | | | | |
|---|---|---|---|---|---|---|---|
| 0.062440 | 0.539050 | 0.032978 | 0.270564 | 0.006596 | 0.056131 | 0.003445 | 0.028796 |

TABLE 2

| | | | | | | | |
|---|---|---|---|---|---|---|---|
| 0.062440 | 0.539050 | 0.032978 | 0.270564 | 0.006596 | 0.056131 | 0.003445 | 0.028796 |
| 0.062448 | 0.539188 | 0.033021 | 0.270426 | 0.006582 | 0.056133 | 0.003448 | 0.028754 |
| 0.062684 | 0.534600 | 0.032841 | 0.273804 | 0.006624 | 0.057224 | 0.003512 | 0.028711 |
| 0.057592 | 0.522994 | 0.028972 | 0.294246 | 0.006075 | 0.056162 | 0.003093 | 0.030867 |
| 0.056856 | 0.522786 | 0.028504 | 0.295997 | 0.006013 | 0.055672 | 0.003036 | 0.031137 |
| 0.056708 | 0.522746 | 0.028454 | 0.296270 | 0.006005 | 0.055638 | 0.003024 | 0.031156 |
| 0.059122 | 0.525245 | 0.030006 | 0.289324 | 0.006245 | 0.056614 | 0.003223 | 0.030222 |
| 0.056489 | 0.523810 | 0.028342 | 0.295983 | 0.005958 | 0.055194 | 0.002989 | 0.031235 |
| 0.062463 | 0.533817 | 0.032649 | 0.275023 | 0.006579 | 0.057217 | 0.003480 | 0.028773 |
| 0.063277 | 0.537513 | 0.033465 | 0.270043 | 0.006685 | 0.057016 | 0.003533 | 0.028469 |
| 0.057021 | 0.522683 | 0.028556 | 0.295878 | 0.006016 | 0.055737 | 0.003038 | 0.031072 |
| 0.056562 | 0.522904 | 0.028361 | 0.296424 | 0.005980 | 0.055524 | 0.003011 | 0.031233 |
| 0.060796 | 0.529095 | 0.031299 | 0.282520 | 0.006426 | 0.057064 | 0.003347 | 0.029454 |
| 0.058398 | 0.532066 | 0.030135 | 0.284691 | 0.006181 | 0.055018 | 0.003131 | 0.030380 |

The same sampling and processing mentioned above are repeated 14 times to obtain 14 sets of the spindle vibration signals during a normal operation. The result 14 sets of normalized eigenvector are shown in TABLE. 2.

Then, a pre-set neural network is trained by using the 14 sets of normalized eigenvector as inputs and the output of zero.

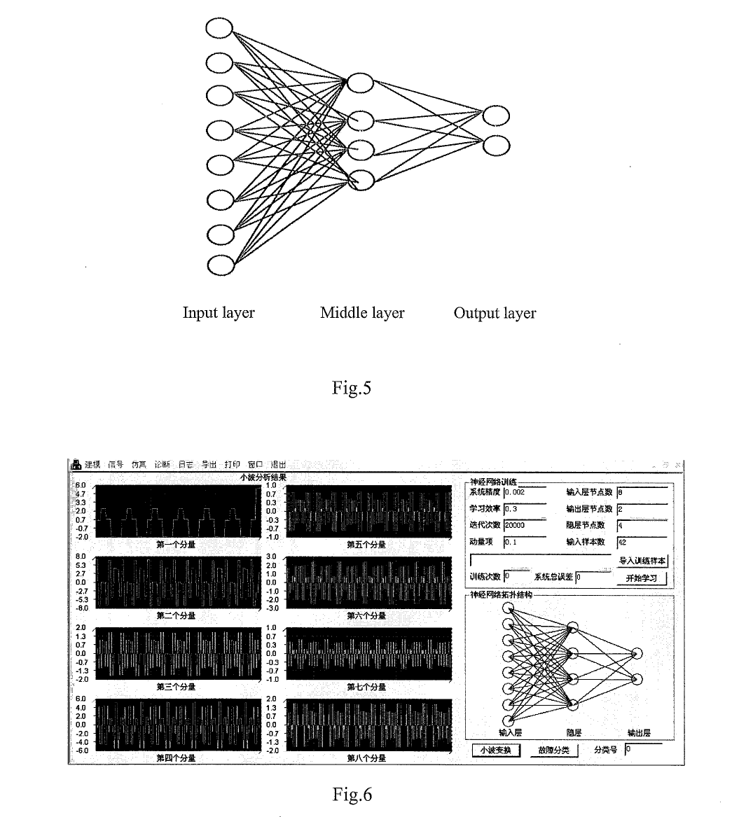

FIG. 5 shows a topology structure of a BP neural network implemented by an embodiment of the present invention.

As shown in FIG. 5, a pre-set BP neural network comprising an input layer, a middle layer and an output layer is established. In an embodiment, the input layer is configured to input the normalized eigenvectors obtained by the wavelet transform of real-time collected signals. The input layer may comprise eight neuron nodes and each node is configured to input one of the eight components of the normalized eigenvector. The middle layer comprises four neuron nodes to process the data from the input layer in order to improve the calculation precision of the neural network. The output layer comprises two neuron nodes and 0 or 1 is used as the output value to respectively represent the status is normal or abnormal indicating the fault.

In the embodiment of the invention, the numbers of nodes in the middle layer, the output layer and the input layer are just examples and the other number of nodes can be determined as desired. In addition, a tansig (S-shaped tangent function) is used as an activation function by the neurons in the middle layer while a logsig (S-shaped log function) is used as the activation function by the neurons in the output layer. However, it will be appreciated by those skilled in the art that the neural network structure, the number of neuron nodes and neuron activation function can be changed as desired.

For example, the design requirements of the neural network according to an embodiment may be: the maximum number of training iterations of the neural network is 20,000 and the output error is less than 0.002.

After the training process, the vibration frequency characteristics of the machine tool spindle in normal status are obtained, as shown in FIG. 6.

FIG. 6 shows the vibration frequency characteristics of the device to be detected under the normal status.

As shown in FIG. 6, the waveforms of the eight components of each vibration signal in the normal status are shown. After the training of neural network shown on a right-hand side of FIG. 6, an output class number of the fault classification is 0, i.e. the status is normal.

In the process of real-time fault detection, the vibration sensors collect the vibration signals of the machine tool spindle in real time and process the signals according to the steps mentioned above. When the normalized eigenvectors obtained from the wavelet transform for the abnormal signals are input to the above mentioned neural network, the output of the neural network is 1, i.e. a fault exists and the alarm is issued.

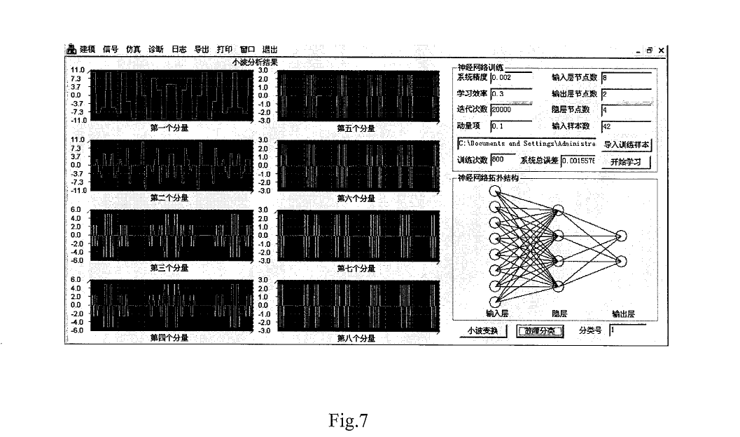

FIG. 7 shows the vibration frequency characteristics of the device to be detected in the failure status.

As shown in FIG. 7, the waveforms of the eight components of each vibration signal under the failure status are shown. According to the comparison shown in FIG. 6, there is significant difference between the waveforms of the eight components of each vibration signal under the failure status and the normal status. Further, after the calculation of neural network shown on the right side of FIG. 7, the class number of fault classification is 1, i.e. the status is abnormal and then the alarm is issued.

It will be appreciated by those skilled in the art that the repeat number is not limited to 14, but can be more or less as desired. In this example, the design requirements: the maximum number of training iterations of the neural network is 20,000; the output error of less than 0.002 may be satisfied with 14 repetitions.

The processing for the acoustic signal is the same as that for the vibration signal. Similarly, the wavelet transform is executed on the acoustic signal to obtain the normalized vectors. The frequency characteristic of the acoustic signal in the normal status is obtained by using the eigenvectors in the normal status to train the neural network. The alarm is issued when the abnormal acoustic signals are input to the neural network and the output of the neural network is 1 i.e. a fault is found.

In addition, when the intelligent detection system is configured as the slave controller, the operation flow is similar to the steps when the system is configured as the main controller as mentioned above. The only difference is that the operation timings are set by the external main controller.

Alternatively, in addition to the above-mentioned processes, the intelligent detection system comprises a self-operation status monitoring module (not shown) to monitor the operation of the system. In addition, the self-operation status monitoring module operates independently with the device to be detected. The failure status or abnormal status in the intelligent system of the present invention comprises at least one of no data collection by the sensors attached to the intelligent system through the data interfaces (such as the RS232 interface, the 485 bus interface), the abnormal operation status of the DAB connected to the CPU through the PC104 bus, an interruption of the communication connection of the network, and so on. When the mentioned failure status occurs, the alarm is issued. In this way, the reliable operation and the timely maintenance of the intelligent detection system are achieved.

The above-mentioned intelligent detection method may be implemented with a software module in the CPU or in memory. In an embodiment, the method can be realized as a physical hardware chip. The main program in the CPU controls the operation mode, the timings and the operation of the external hardware chip and monitors the self-operation status of the intelligent detection system. In addition, the data collected by the sensors is stored in the memory of the CPB and is transmitted to the other devices through the RS232 serial interface, the 485 bus interface, the network interface, the CAN bus interface and/or the photoelectric conversion interface.

An embodiment of the present invention is directed to an embedded intelligent detection system and method. The intelligent detection system comprises embedded system architecture and software programming to realize the data collection of the temperature sensor, the vibration sensor and/or the acoustic sensor in real time. An embodiment of the invention can effectively replace the existing manual testing method, realize an online monitoring and alarm, and improve the operation security of the device.

As mentioned above, the existing fault detection techniques for the mechanical parts of a machine tool (e.g. NC machine tool) depend on manual testing and focus on the remote fault diagnosis. An embodiment of the present invention applies the intelligent processing algorithms and diagnostic method to the embedded system to achieve the intelligent fault detection of a mechanical device.

It should be understood that, the above-mentioned embodiments are for purposes of illustration and explanation and are not intended to be limiting. Therefore, without departing from the spirit and scope of this invention, any change, equivalent and modification should be made in the scope of the invention. In addition, all changed and modified embodiments fall into the scope defined by the following claims.

1. An intelligent detection system for device fault detection, the system connected to a plurality of sensors, the plurality of external sensors configured to collect processing data of a device to be detected, the system comprising:
a central processing board (CPB) including a central processing unit (CPU) and a plurality of data interfaces connected to the CPU;
a data acquisition board (DAB) connected to one or more sensors of the plurality of external sensors and configured to process the data collected by the sensors;
a synchronous communication board (SCB) configured to maintain communication between the CPB and the DAB; and
a plurality of connection plugs configured to provide a connection among the CPB, the DAB, and the SCB for data transformation;
wherein, the CPU is configured to analyze the data collected by the sensors, and issue an alarm information when a value of the collected data does not fall into a preset range and it is determined that the device is in an abnormal status; and when the value of the collected data falls into the pre-set range, it is determined that the device is in a normal status.

2. The intelligent detection system according to claim 1, wherein the plurality of sensors include at least one of a vibration sensor, an acoustic sensor, and a temperature sensor.

3. The intelligent detection system according to claim 2, wherein the CPU is configured to analyze the data collected by the temperature sensor and the alarm information is issued when the value of the collected data does not fall into the preset range.

4. The intelligent detection system according to claim 2, wherein the CPU is configured to analyze the data collected by the vibration sensor to obtain a vibration amplitude, pre-set a normal range of the vibration amplitude and issue the alarm information when the obtained vibration amplitude does not fall into the preset normal range of the vibration amplitude; and/or
analyze the signals collected by the vibration sensor to collect a vibration frequency, pre-set a vibration frequency range for the normal status, and issue the alarm information when the obtained vibration frequency does not fall into the pre-set vibration frequency range.

5. The intelligent detection system according to claim 2, wherein the CPU is configured to analyze an acoustic signal collected by the acoustic sensor to collect an acoustic pressure level, issue the alarm information when the collected acoustic pressure level is greater than a pre-set maximum; and/or
analyze an acoustic signal collected by the acoustic sensor to collect a acoustic frequency, pre-set a acoustic frequency range for the normal status and issue the alarm information when the collected acoustic frequency does not fall into the pre-set acoustic frequency range.

6. (canceled)

7. (canceled)

8. (canceled)

9. (canceled)

10. (canceled)

11. The intelligent detection system according to claim 1, wherein the DAB is a multi-channel high speed data acquisition board.

12. The intelligent detection system according to claim 1, further comprising a power supply and a corresponding circuit configured to provide a constant voltage for the CPB, the DAB and the plurality of sensors.

13. The intelligent detection system according to claim 1, further comprising a housing configured to receive and protect internal components of the system; and
two openings are provided on two sides of the housing respectively for installing sockets used by the power supply, the sensor leads and/or the external communication interfaces.

14. (canceled)

15. The intelligent detection system according to claim 1, further comprising a self-operation status monitoring module configured to monitor the operation of the system and issue the alarm information in response to a faulty operation of the system.

16. The intelligent detection system according to claim 1, wherein the abnormal status comprise at least one of no data collection by the sensors, abnormal operation status of the DAB, and an interruption of the connection among the data interfaces.

17. A method of device fault detection for an intelligent detection system, the system connected to a plurality of sensors configured to collect processing data of a device to be detected and comprising: a central processing board (CPB), a data acquisition board (DAB), a synchronous communication board (SCB) and a plurality of connection plugs, the CPB, DAB and SCB are connected to each other via the plurality of connection plugs for data transmission; the method comprising:
initializing the system by initializing all devices and interfaces of the system;
setting an operation mode of the system as a main controller or a slave controller;
setting an operation timings and task priorities of each device and interface respectively;
collecting data according to the set timings and priorities; and
analyzing the collected data to determine whether or not the device to be detected is in a normal status according to an analysis result.

18. The method according to claim 17, wherein the initializing comprises detecting the CPB, the DAB and the SCB, and determining whether the device connected via the external interface is in normal status.

19. The method according to claim 17, wherein setting the operation mode comprises:
generating control commands, by the intelligent detection system, to control the operation of the external devices when the operation mode of the intelligent detection system is set as a main controller; and
transmitting the control commands, by the intelligent detection system in response to an external main controller when the operation mode of the intelligent detection system is set as a slave controller.

20. The method according to claim 17, wherein setting the operation timings comprises setting the timings and the task priorities of data collection, data processing and data transmission for the plurality of sensors respectively.

21. The method according to claim 17, wherein the analyzing comprises:
issuing the alarm information when a value of the collected data does not fall into a pre-set range and determining that the device to be detected is in an abnormal status;
determining that the device to be detected is in a normal status when the value of the collected data falls into the pre-set range and returning to the step of setting the operation mode for a next detection.

22. The method according to claim 21, wherein the analyzing further comprises setting a normal temperature range in advance, and issuing the alarm information when the value of the data collected by the temperature sensor does not fall into the normal temperature range.

23. The method according to claim 21, wherein the analyzing further comprises:
analyzing a vibration signal collected by a vibration sensor to collect vibration amplitude, presetting a normal range of the vibration amplitude, and issuing the alarm information when the collected vibration amplitude does not fall into the normal range of the vibration amplitude; and/or
analyzing the vibration signal collected by the vibration sensor to collect a vibrational frequency, pre-setting a normal range of the vibrational frequency, comparing the vibrational frequency collected with the pre-set normal range of the vibrational frequency, and issuing the alarm information when the vibration frequency collected does not fall into the pre-set vibration frequency range.

24. The method according to claim 21, wherein the analyzing further comprises: analyzing an acoustic signal collected by an acoustic sensor to collect a sound pressure level, pre-setting a sound pressure level maximum and issuing the alarm when the sound pressure level collected is greater than the maximum; and/or
analyzing an acoustic signal collected by an acoustic sensor to collect an acoustic frequency, pre-setting a normal range of the acoustic frequency, comparing the acoustic frequency collected with the pre-set normal range of the acoustic frequency, and issuing the alarm information when the collected acoustic frequency does not fall into the pre-set acoustic frequency range.

25. The method according to claim 17, further comprising self-operation status monitoring the operation of the system and issuing the alarm information in response to a faulty operation of the system.

26. The method according to claim 25, wherein the faulty operation comprises at least one of no data collection by sensors, abnormal operation status of DAB, and an interruption of the connection among the data interfaces status.
